(19) United States
(12) Patent Application Publication
(10) Pub. No.: US 2005/0096969 A1
(43) Pub. Date: May 5, 2005

(54) Market share forecasting for businesses selling products or services to other businesses (non-consumer markets)

(76) Inventor: Robert Allen Sevio, Cary, NC (US)

Correspondence Address: Robert Allen Sevio, 203 Annandale Drive, Cary, NC, 27511, US

(21) Appl. No.: 10/702,191

(22) Filed: Nov. 5, 2003

(51) Int. Cl. G06F 17/60

(52) U.S. Cl. 705/10

(57) ABSTRACT

A computer-implemented forecasting method by which a business, selling a product/service to a business (non-consumer) market, can, for its forecast period, input market size and competitive data, to: (1) forecast its market share, as a percent of the total units of currency (for example, U.S. dollars) to be captured in the market, (2) forecast its market share, in units of currency (for example, U.S. dollars), (3) forecast a product/service pricing ratio, versus its leading competitor, that will be necessary for the forecasting business to use in order to attain its forecasted market share, (4) forecast its leading competitor's market share, as a percent of the total units of currency (for example, U.S. dollars) to be captured in the market, and, (5) forecast the combined market share of all of its other competitors, as a percent of the total units of currency (for example, U.S. dollars) to be captured in the market.

### REFERENCES CITED

### U.S. pATENT DOCUMENTS

| | | | |
|---|---|---|---|
| 5,461,699 | Oct. 24, 1995 | Arbabi, et al. | 706/21; 706/25; 706/925 |
| 6,009,407 | Dec. 28, 1999 | Garg | 705/10; 705/7; 705/14; |
| | | | 705/28 |
| 6,249,768 | Jun. 19, 2001 | Tulskie, Jr., et al. | 705/7; 700/266 |
| 6,415,267 | Jul. 2, 2002 | Hagen | 705/35; 705/36 |
| 6,606,615 | Aug. 12, 2003 | Jennings, et al. | 706/45 |

### OTHER REFERENCES

Business Ware UK Ltd, “BusinessMap”, From: http://www.businessware.co.uk, 2004 Business Forecast Systems, “Forecast Pro”, From: http://www.forecastpro.com/, 2004 Market Modelling Limited, “Matrix”, From: http://www.market-modelling.co.uk/, 2004 The Marketing Process Company, “EXMAR”, From: http://www.themarketingprocessco.com/index.htm, 2004

### BACKGROUND

Increasing competition, shorter product life cycles, and frequent business failures underscore that businesses must do a better job of forecasting market share. This method is intended to address this problem, in business-to-business markets.

This method for providing market share predictions and pricing guidance has been developed by analyzing the performance of companies in business-to-business markets (non-consumer markets). It has also been developed by modeling thousands of hypothetical business-to-business markets. It has been matured over a period of several years by Robert Allen Sevio, whose experience is briefly discussed below. The inventor of this method, Robert Allen Sevio, currently assists companies by: Ranking Market Opportunities, Forecasting Market Share, Developing Marketing Plans For most of the past 17 years, Robert Allen Sevio has consulted for companies to help them identify and address market opportunities. Some current and past clients include: a provider of network integration services, a provider of safety certification services, a provider of mainframe management software, and a provider of industrial power, heating, and air conditioning systems. Robert Allen Sevio's other professional experience includes:

Manager of Marketing Research and Business Planning for Nortel (formerly Northern Telecom)

Director of Marketing Services for ITT's Business and Consumer Communications Division Robert Allen Sevio is a graduate of the Rochester Institute of Technology, School of Business, 1966.

### BRIEF SUMMARY OF ROBERT ALLEN SEVIO'S INVENTION

A computer-implemented method by which a business, selling a product/service to a business (non-consumer) market, can, forecast market share for itself and its competitors, and also forecast a pricing ratio, versus its leading competitor, needed to achieve its market share.

Market Resource (2.) Product/Service Research & Development Personnel in Place, (Importance Weight: 0.0030)

Respective Rating Guidelines for Market Resource (2.):
A rating must be provided, ranging from 1 to 100, where the rating represents the number of product/service research and development personnel in place to pursue the business (non-consumer) market (the entire market size, per (b) above), as a percent (to a maximum of 100) of the number of product/service research and development personnel needed to capture the market (the entire market size), per (b) above).

When Rating Research and Development Personnel in Place:
Ratings must be increased for research and development personnel that business partners have in place to serve the market.

Research and development personnel specifically include those responsible for any combination of:
Planning, researching, evaluating, selecting, defining, designing, developing, and testing the product/service, as well as for providing product/service training to internal personnel Research and development personnel DO NOT include those that actually produce products or fulfill services.
   Market Resource (3.) Production/Fulfillment Personnel in Place, (Importance Weight: 0.0020)

Respective Rating Guidelines for Market Resource (3.):

A rating must be provided, ranging from 1 to 100, where the rating represents the number of production/fulfillment personnel in place to pursue the business (non-consumer) market (the entire market size, per (b) above), as a percent (to a maximum of 100) of the number of production/fulfillment personnel needed to capture the market (the entire market size), per (b) above).

When Rating Production/Fulfillment Personnel in Place:
Ratings must be increased for production/fulfillment personnel that business partners have in place to serve the market.
Production/fulfillment personnel specifically include those responsible for:

1) Any of the following activities in regards to a providing a product (for the initial product, warranty related products/parts, after warranty products/parts, product upgrades): purchasing, manufacturing, storing, displaying, and delivery

2) Any of the following activities in regards to fulfilling a service: initial service fulfillment, warranty related service fulfillment, after warranty service fulfillment, fulfillment of service upgrades

Market Resource (4.) Marketing Personnel in Place, (Importance Weight: 0.0025)

Respective Rating Guidelines for Market Resource (4.):

A rating must be provided, ranging from 1 to 100, where the rating represents the number of marketing personnel in place to pursue the business (non-consumer) market (the entire market size, per (b) above), as a percent (to a maximum of 100) of the number of marketing personnel needed to capture the market (the entire market size), per (b) above).

When Rating Marketing Personnel in Place for Each Division:
Ratings must be increased for marketing personnel that business partners have in place to serve the market Marketing personnel specifically include those responsible for:
Product/service advertising, promotion, market research, market planning, etc.
   Market Resource (5.) Sales Personnel in Place, (Importance Weight: 0.0015)

Respective Rating Guidelines for Market Resource (5.):

A rating must be provided, ranging from 1 to 100, where the rating represents the number of sales personnel in place to pursue the business (non-consumer) market (the entire market size, per (b) above), as a percent (to a maximum of 100) of the number of sales personnel needed to capture the market (the entire market size), per (b) above).

When Rating Sales Personnel in Place for Each Division:
Ratings must be increased for sales personnel that business partners have in place to serve the market Sales personnel specifically include those responsible for:
Sales training, pre-sales support, and selling
   Market Resource (6.) Support Personnel in Place, (Importance Weight: 0.0010)

Respective Rating Guidelines for Market Resource (6.):

A rating must be provided, ranging from 1 to 100, where the rating represents the number of support personnel in place to pursue the business (non-consumer) market (the entire market size, per (b) above), as a percent (to a maximum of 100) of the number of support personnel needed to capture the market (the entire market size), per (b) above).

When Rating Support Personnel in Place for Each Division:
Ratings must be increased support personnel that business partners have in place to serve the market.
Support personnel specifically include those that provide:
The interface between customers and company personnel that are responsible for satisfying customers' post-sale requests, for example, in-warranty and after-warranty requests
   (d) calculating the total strength of market resources, respectively for the forecasting business and its leading competitor, with such strength of market resources ranging from 1 to 100, equaling the total amount that will result from multiplying each respective rating that will have been input for the 6 market resources in (c) above, by each respective importance weight, as provided by this method, for the 6 market resources in (c) above
   (e) for both the forecasting business and its leading competitor, inputting ratings, ranging from 1 to 100, for the 3 market receptivity factors shown below, per the Respective Rating Guidelines also shown below, where the ratings represent the current level of the market receptivity factor as compared to the maximum level of 100, with each of the 3 market receptivity factors having an importance weight, as a portion of 1.0000, also as shown below
   Market Receptivity Factors to be Rated (For the Forecasting Business and its Leading Competitor Respectively):

Market Receptivity Factor (1.) Confidence Level (For Stability), (Importance Weight: 0.2970)

Respective Rating Guidelines for Market Receptivity Factor (1.):
A rating must be provided, ranging from 1 to 100, where the rating represents the current level of purchasers'/decision makers' confidence in the stability (Financial, Ethical, Political) of the business to perform as expected, as compared to the maximum level of 100.

Ratings should allow for confidence in the stability of business/market partners too (e.g., key suppliers, key distributors, etc.).

If purchasers'/decision makers' receptivity to a respective division's product/service is expected to be rated at LESS THAN SATISFACTORY, per Market Receptivity Factor (2.), below, then that division may receive a confidence level rating of ONLY 1. Also see (W), below.

| (W) If a business has ANY | Then the respective business |
|---|---|
| Market Resource, | may receive a MAXIMUM |
| per (c) above, rated at: | Confidence Level of: |
| 1 | 79 |
| 2 to 9 | 80 |
| 10 to 24 | 85 |
| 25 to 49 | 90 |
| 50 to 99 | 95 |

Market Receptivity Factor (2.) Match to Market Needs (Purchasers'/Decision Makers' Receptivity to the Product/Service), (Importance Weight: 0.6930)

Respective Rating Guidelines for Market Receptivity Factor (2.)

NOTE: This Market Receptivity Factor must be rated according to whether or not the market is a Non-Displacement Market, or a Displacement Market, each of which is defined below.

Match to Market Needs For Non-Displacement Markets:
Non-Displacement Markets Defined

In a Non-Displacement Market, one of the following is true.

1) A competitor will NOT need to displace another competitor's product/service to make a sale. Or . . .

2) In spite of needing to displace another competitor's product service to make a sale, the displacing competitor's product/service will NOT require customers to incur start-up expenses or interruption costs, that are not also required by the in-place competitor's product/service. This is not likely to be the case with a product/service of any complexity.

A rating must be provided, according to the guide below, where the rating represents the current level of purchasers'/decision makers' receptivity to the offered product/service: attributes of the deliverable, experience record, implementation impact, availability, follow-through, support, and other services, as compared to the maximum level of 100.

Pricing and market share SHOULD NOT be considered when rating receptivity.

| Guide for rating both businesses in a Non- | |
|---|---|
| Displacement Market | Receptivity Rating/Range |
| A. For a LESS THAN SATISFACTORY | 1 |
| product/service | |
| B. For a SATISFACTORY TO BETTER | 70-85, also see (W), below |
| THAN SATISFACTORY product/service | |
| C. For a GOOD TO EXCEPTIONAL | 86-100, also see (W), below |
| product/service | |

| | Then REDUCE the |
|---|---|
| (W) If a business | product/service rating you were |
| has been rated at a | planning to give to the |
| Confidence Level of: | respective business by: |
| 90 to 94 | 7% |
| 85 to 89 | 12% |
| 80 to 84 | 19% |
| 70 to 79 | 27% |
| 60 to 69 | 36% |
| 50 to 59 | 46% |
| 40 to 49 | 57% |
| 30 to 39 | 69% |
| 20 to 29 | 82% |
| 10 to 99 | 96% |
| 1 to 9 | 99% |

Match to Market Needs For Displacement Markets:

Displacement Markets Defined

In a Displacement Market, BOTH of the following are true.

1) A competitor will need to displace another competitor's product/service to make a sale.

AND AS IMPORTANTLY . . .

2) The displacing competitor's product/service will require customers to incur start-up expenses or interruption costs, that are not required by the in-place competitor's product/service. Displacement Markets must be evaluated separately from non-displacements markets. Also, if only a portion of the purchasers/decision makers is in a Displacement Market, that portion must be evaluated as a separate Displacement/Market

A rating must be provided, according to the guide below, where the rating represents the current level of purchasers'/decision makers' receptivity to the offered product/service: attributes of the deliverable, experience record, implementation impact, availability, follow-through, support, and other services, as compared to the maximum level of 100.

Pricing and market share SHOULD NOT be considered when rating receptivity.

| Guide for rating both businesses in | |
|---|---|
| a Displacement Market: Rate | |
| one division as In-Place and one as | |
| Displacing. Both may be rated | |
| as Displacing if both are trying to | |
| displace a third competitor. | Receptivity Rating/Range |
| A. For a LESS THAN SATISFACTORY | An In-Place Division, 3, also |
| product/service | see (X), below A |
| | Displacing Division 1 |
| B. For a SATISFACTORY TO BETTER | An In-Place Division 70-85, |
| THAN SATISFACTORY product/service | also see (X), below A |
| | Displacing Division, |
| | see (Y), below |
| C. For a GOOD TO EXCEPTIONAL | An In-Place Division 86-100, |
| product/service | also see (X), below A |
| | Displacing Division, |
| | see (Y), below |

| | Then REDUCE the |
|---|---|
| (X) If a Division | Product/Service Rating You |
| Has Been Rated at a | Were Planning to Give to the |
| Confidence Level of: | Respective Division by: |
| 90 to 94 | 7% |
| 85 to 89 | 12% |
| 80 to 84 | 19% |
| 70 to 79 | 27% |
| 60 to 69 | 36% |
| 50 to 59 | 46% |
| 40 to 49 | 57% |
| 30 to 39 | 69% |
| 20 to 29 | 82% |
| 10 to 99 | 96% |
| 1 to 9 | 99% |

| | Then the MAXIMUM rating |
|---|---|
| | the Displacing Business |
| | may receive for |
| (Y) If the Displacing | an EXCEPTIONAL |
| Business' Confidence Level is: | Product/Service is: |
| 49 or less | 1, also see (Z), below |
| AND the In-Place Division's is 90 to 100 | |
| 49 or less | 3, also see (Z), below |
| AND the In-Place Division's is 85 to 89 | |
| 49 or less | 6, also see (Z), below |
| AND the In-Place Division's is 80 to 84 | |
| 49 or less | 10, also see (Z), below |
| AND the In-Place Division's is 70 to 79 | |
| 49 or less | 16, also see (Z), below |
| AND the In-Place Division's is 60 to 69 | |
| 49 or less | 24, also see (Z), below |
| AND the In-Place Division's is 50 to 59 | |
| 49 or less | 35, also see (Z), below |
| AND the In-Place Division's is 49 or less | |
| 50 to 59 | 3, also see (Z), below |
| AND the In-Place Division's is 90 to 100 | |
| 50 to 59 | 6, also see (Z), below |
| AND the In-Place Division's is 85 to 89 | |
| 50 to 59 | 10, also see (Z), below |
| AND the In-Place Division's is 80 to 84 | |
| 50 to 59 | 16, also see (Z), below |
| AND the In-Place Division's is 70 to 79 | |
| 50 to 59 | 24, also see (Z), below |
| AND the In-Place Division's is 60 to 69 | |
| 50 to 59 | 35, also see (Z), below |
| AND the In-Place Division's is 50 to 59 | |
| 50 to 59 | 50, also see (Z), below |
| AND the In-Place Division's is 49 or less | |
| 60 to 69 | 6, also see (Z), below |
| AND the In-Place Division's is 90 to 100 | |
| 60 to 69 | 10, also see (Z), below |
| AND the In-Place Division's is 85 to 89 | |
| 60 to 69 | 16, also see (Z), below |
| AND the In-Place Division's is 80 to 84 | |
| 60 to 69 | 24, also see (Z), below |
| AND the In-Place Division's is 70 to 79 | |
| 60 to 69 | 35, also see (Z), below |
| AND the In-Place Division's is 60 to 69 | |
| 60 to 69 | 50, also see (Z), below |
| AND the In-Place Division's is 50 to 59 | |
| 60 to 69 | 70, also see (Z), below |
| AND the In-Place Division's is 49 or less | |
| 70 to 79 | 10, also see (Z), below |
| AND the In-Place Division's is 90 to 100 | |
| 70 to 79 | 16, also see (Z), below |
| AND the In-Place Division's is 85 to 89 | |
| 70 to 79 | 24, also see (Z), below |
| AND the In-Place Division's is 80 to 84 | |
| 70 to 79 | 35, also see (Z), below |
| AND the In-Place Division's is 70 to 79 | |
| 70 to 79 | 50, also see (Z), below |
| AND the In-Place Division's is 60 to 69 | |
| 70 to 79 | 70, also see (Z), below |
| AND the In-Place Division's is 50 to 59 | |
| 70 to 79 | 95, also see (Z), below |
| AND the In-Place Division's is 49 or less | |
| 80 to 84 | 16, also see (Z), below |
| AND the In-Place Division's is 90 to 100 | |
| 80 to 84 | 24, also see (Z), below |
| AND the In-Place Division's is 85 to 89 | |
| 80 to 84 | 35, also see (Z), below |
| AND the In-Place Division's is 80 to 84 | |
| 80 to 84 | 50, also see (Z), below |
| AND the In-Place Division's is 70 to 79 | |
| 80 to 84 | 70, also see (Z), below |
| AND the In-Place Division's is 60 to 69 | |
| 80 to 84 | 95, also see (Z), below |
| AND the In-Place Division's is 50 to 59 | |
| 80 to 84 | 97, also see (Z), below |
| AND the In-Place Division's is 49 or less | |
| 85 to 89 | 24, also see (Z), below |
| AND the In-Place Division's is 90 to 100 | |
| 85 to 89 | 35, also see (Z), below |
| AND the In-Place Division's is 85 to 89 | |
| 85 to 89 | 50, also see (Z), below |
| AND the In-Place Division's is 80 to 84 | |
| 85 to 89 | 70, also see (Z), below |
| AND the In-Place Division's is 70 to 79 | |
| 85 to 89 | 95, also see (Z), below |
| AND the In-Place Division's is 60 to 69 | |
| 85 to 89 | 97, also see (Z), below |
| AND the In-Place Division's is 50 to 59 | |
| 85 to 89 | 99, also see (Z), below |
| AND the In-Place Division's is 49 or less | |
| 90 to 100 | 35, also see (Z), below |
| AND the In-Place Division's is 90 to 100 | |
| 90 to 100 | 50, also see (Z), below |
| AND the In-Place Division's is 85 to 89 | |
| 90 to 100 | 70, also see (Z), below |
| AND the In-Place Division's is 80 to 84 | |
| 90 to 100 | 95, also see (Z), below |
| AND the In-Place Division's is 70 to 79 | |
| 90 to 100 | 97, also see (Z), below |
| AND the In-Place Division's is 60 to 69 | |
| 90 to 100 | 99, also see (Z), below |
| AND the In-Place Division's is 50 to 59 | |
| 90 to 100 | 100, also see (Z), below |
| AND the In-Place Division's is 49 or less | |

(Z) A lower rating must be given if the product/service is less than EXCEPTIONAL. (For example, a product/service that would qualify for a rating of 50, if EXCEPTIONAL, would receive a rating of 45, if it were 90% of EXCEPTIONAL.)
Market Receptivity Factor (3.) Name Recognition, (Importance Weight: 0.0100)

Respective Rating Guidelines for Market Receptivity Factor (3.):

A rating must be provided, ranging from 1 to 100, where the rating represents the current level of purchasers'/decision makers' name recognition (awareness) of the offered product/service, as compared to the maximum level of 100.

If a business' product/service has been rated at LESS THAN SATISFACTORY for Match to Market Needs, Market Receptivity Factor (2.), above, then that division may receive a rating here of ONLY 1. Also see (Z).

| (Z) If a business | Then REDUCE the name recognition |
|---|---|
| has been rated at a | (awareness) rating you were planning |
| Confidence Level of: | to give to the respective business by: |
| 90 to 94 | 7% |
| 85 to 89 | 12% |
| 80 to 84 | 19% |
| 70 to 79 | 27% |
| 60 to 69 | 36% |
| 50 to 59 | 46% |
| 40 to 49 | 57% |
| 30 to 39 | 69% |
| 20 to 29 | 82% |
| 10 to 99 | 96% |
| 1 to 9 | 99% |

(f) calculating total market receptivity, respectively for the forecasting business and its leading competitor, such market receptivity ranging from 1 to 100, equaling the total amount that will result from multiplying each respective rating that will have been input for the 3 market receptivity factors in (e) above, by each respective importance weight, as provided by this method, for the 3 market receptivity factors in (e) above
(g) inputting estimates, as follows in (1) through (4) immediately below, of the number of other competitors (competitors in addition to the forecasting business and its leading competitor) that are trying to capture a share of the business (non-consumer) market for the forecast period:

(1) inputting the number of other competitors that are trying to capture a share of the business (non-consumer) market for the forecast period, whose total strength of market resources is 91 to 100% (where 0.955, is the average total strength of market resources, in decimal format, used by this method) as strong as that of the forecasting business' leading competitor's total strength of market resources, as determined per (d) above

(2) inputting the number of other competitors that are trying to capture a share of the business (non-consumer) market for the forecast period, whose total strength of market resources is 81 to 90% (where 0.855, is the average total strength of market resources, in decimal format, used by this method) as strong as that of the forecasting business' leading competitor's total strength of market resources, as determined per (d) above

(3) inputting the number of all other competitors that are trying to capture a share of the business (non-consumer) market for the forecast period (3) (1.) inputting the average total strength of market resources, for the number of all other competitors, as input per (3), immediately above, that are trying to capture a share of the business (non-consumer) market for the forecast period, whose total strength of market resources ranges from 1 to 80% (where 0.01 to 0.80, must be input for this method) as strong as that of the forecasting business' leading competitor's total strength of market resources, as determined per (d) above

(h) calculating the total strength of market resources for all other competitors (competitors in addition to the forecasting business and its leading competitor) that are trying to capture a share of the business (non-consumer) market for the forecast period, where such calculation equals the total of: the number of other competitors input for (g) (1) immediately above, multiplied by total strength of market resources percentage used in (g) (1) immediately above, multiplied by the total strength of market resources for forecasting business' leading competitor, per (d) above, plus, the number of other competitors input for (g) (2) immediately above, multiplied by total strength of market resources percentage used in (g) (2) immediately above, multiplied by the total strength of market resources for forecasting business' leading competitor, per (d) above, plus, the number of other competitors input for (g) (3) immediately above, multiplied by total strength of market resources percentage used in (g) (3) (1.) immediately above, multiplied by the total strength of market resources for forecasting business' leading competitor, per (d) above

(i) calculating the total strength of market resources for all competitors combined (the forecasting business, its leading competitor, and other competitors that are trying to capture a share of the business (non-consumer) market for the forecast period), such calculation equaling the total of (d) above plus (h) above

(j) generating forecasted market share in terms of:

(1) the percent of the total units of currency (market size, for example, U.S. dollars) that is estimated to be captured by the forecasting business in the business (non-consumer) market, based on dividing the total strength of market resources for the forecasting business, per (d) above, by the total strength of market resources for all competitors combined, per (i) immediately above

(2) the portion of market size, in units of currency, (for example, U.S. dollars) that is estimated to be captured by the forecasting business in the business (non-consumer) market, based on multiplying (b) above, by (0) (1) immediately above

(3) a product/service pricing ratio, versus its leading competitor, that will be necessary for the forecasting business to use in order to attain its forecasted market share in the business (non-consumer) market, based on dividing total market receptivity for the forecasting business, per (f) above, by total market receptivity for its leading competitor, also per (f) above

(4) the percent of the total units of currency (market size, for example, U.S. dollars) that is estimated to be captured by the forecasting business' leading competitor in the business (non-consumer) market, based on dividing the total strength of market resources for the forecasting business' leading competitor, per (d) above, by the total strength of market resources for all competitors combined, per (i) above

(5) the percent of the total units of currency (market size, for example, U.S. dollars) that is estimated to be captured by all other competitors in the business (non-consumer) market, based on dividing the total strength of market resources for all other competitors, per (h) above, by the total strength of market resources for all competitors combined, per (i) above

[image]

[image]

[image]

[image]

1. A computer-implemented forecasting method by which a business (hereinafter referred to as, the forecasting business) that is selling a product/service to a business (non-consumer) market, can, (1) forecast its market share, as a percent of the total units of currency to be captured in the market, (2) forecast its market share, in units of currency, (3) forecast a product/service pricing ratio, versus its leading competitor, that will be necessary for the forecasting business to use in order to attain its forecasted market share, (4) forecast its leading competitor's market share, as a percent of the total units of currency to be captured in the market, and, (5) forecast the combined market share of all of its other competitors, as a percent of the total units of currency to be captured in the market, said method comprising the steps of:
(a) inputting the forecast period (the time period for which the business (non-consumer) market is being evaluated by the forecasting business (for example, years 2004 through 2008)
(b) inputting an estimate of market size: the size of the business (non-consumer) market, in total units of currency (for example, U.S. dollars) to be captured by all competitors combined, over the forecast period (as defined per (a) immediately above)
(c) for the forecasting business and its leading competitor respectively, inputting ratings ranging from 1 to 100, for 6 market resources, shown below, as per the Respective Rating Guidelines, also shown below, where the ratings represent the level of market resources currently available to pursue the respective business (non-consumer) market (the entire market size, per (b) above), as a percent (to a maximum of 100) of the market resources needed to capture the entire market size, per (b) above, with each of the 6 market resources having an importance weight, as a portion of 1.0000, also shown below
Each Market Resource must be rated, for the forecasting business and its leading competitor respectively, as follows:
Market Resource (1.) Funds Committed/Available, (importance weight: 0.9900)
Respective Rating Guidelines for Market Resource (1.):
A rating must be provided, ranging from 1 to 100, where the rating represents the amount of funds committed/available to pursue the business (non-consumer) market (the entire market size, per (b) above), as a percent (to a maximum of 100) of finds needed to capture the market (the entire market size), per (b) above).
When Rating Funds Committed/Available:
Ratings must be increased for funds that business partners have committed, for example, for funds that you estimate suppliers or distributor channels currently have made available, specifically to help the respective division to serve the market
Ratings must be decreased for funds that are currently available, but that will need to be spent to get the respective product/service ready to sell (specifically for the cost of product/service research and development, facilities, training, start-up/intense advertising and promotion).
